(19) United States
(12) Patent Application Publication
(10) Pub. No.: US 2015/0186406 A1
(43) Pub. Date: Jul. 2, 2015

(54) SYSTEM AND METHOD FOR FACILITATING INTERPERSONAL CONNECTIONS

(71) Applicant: Studio Nadimi, LLC, Arlington, TX (US)

(72) Inventor: Sayyid Abrahim NADIMI, Arlington, TX (US)

(21) Appl. No.: 14/144,756

(22) Filed: Dec. 31, 2013

(51) Int. Cl. G06F 17/30

(52) U.S. Cl. CPC G06F 17/30174; G06F 17/30289; G06F 17/30699

(57) ABSTRACT

A method of facilitating interpersonal connections includes compiling a plurality of network databases, each being associated with one of a plurality of remote devices and each including contact relationship data for one or more level 1 contacts from the associated remote device. The contact relationship data for each contact includes: a contact identifier, contact information, one or more contact categories, and a contact sharing authorization identifier. A query is received from a first remote device and includes one or more query categories for matching with contact categories. Query results are generated by querying the contact relationship data within the databases for all level 1 contacts of, and for predetermined level 2 contacts associated with, the first remote device. The queried level 2 contacts are determined by each contact sharing authorization identifier respectively associated with each level 2 contact. The query results are sent to the first remote device.

### FIELD OF THE INVENTION

The field of the present invention relates to systems and methods for arranging interpersonal connections between two or more individuals.

### BACKGROUND OF THE INVENTION

In the current market, most business and personal connections are formed and maintained through networking applications that operate on mobile devices, such as smart phones and tablets, and through networking websites on the Internet that may be accessed through any personal computing device, including desktop and laptop computers and mobile devices. Frequently, a networking website also has a networking application that may be used as a secondary front end to access the databases underlying the website on a backend server. As these networking applications offer the same or most of the same functionality that is provided through access from a web browser on a desktop or laptop computer, the remainder of this description applies equally to networking websites and networking applications. The predominant commonality between most the networking websites (and thus also between most networking applications) is that the user is required to access the system and actively send out “invite requests” to personal contacts who are identified by the user, so that the user can begin to build their own list of network contacts. As an alternative, a user may be able to upload their own list of personal contacts to the web/application server and have the server send out invite requests to those personal contacts. As a user's personal contacts respond to the invite requests, that user's network contacts list grows through the networking website.

Hereinafter, a user's contacts that are shared, in some capacity, with others over a network are referred to as “network contacts,” and a user's entire list of known contacts, which may include network contacts and contacts which are not shared through a networking website on which that user is active, are referred to as “personal contacts.” The group of network contacts may be a subset of the group of personal contacts, although it is also possible that these two groups of contacts may be identical.

These networking websites present different problems for different individuals, and for some these problems may be sufficient to prevent an individual from joining and actively using the networking site. Some networking sites provide privacy features that apply to all of a user's network contacts. These privacy features may provide the ability to make all of a user's network contacts public, and therefore searchable by the public, the ability to make all of a user's network contacts viewable, and searchable, only to the user's network contacts, or the ability keep all of a user's network contacts private.

Despite the privacy features that such networking websites provide, some individuals choose not to use the networking websites because the websites include undesirable features. On possible undesirable feature, to some individuals, may be actually having a public, or even a semi-public, profile, as these sites generally do not provide an option to participate without having at least a semi-public profile. Another may be the “news feeds,” “status updates,” or other information that these websites filter to the user based on the user's interests and activities of the user's network contacts.

The search features of such networking websites can be valuable to the users, however the details that are searchable are highly dependent upon what is publicly available in other users' profiles. On networking websites that have minimal privacy control features, much of each users' profile may be searched by others users of the networking website. On networking websites that provide more extensive privacy controls, searches may omit highly relevant results because one or more of a user's network contacts have privacy controls set to keep their own profile information private.

In view of the existing state of networking websites and networking applications, a better mix of privacy controls and searching is desirable to enable people to make new interpersonal connections.

### SUMMARY OF THE INVENTION

The present invention is directed toward a system and method for facilitating interpersonal connections. The interpersonal connections that are made may serve any type of purpose, from a business to business connection, to a business to consumer connection, to a service provider to consumer connection, to a connection between people on a personal level, e.g. recreational activities, dating, and the like. Certain systems and methods may be configured to serve niche markets, or they may be configured to serve multiple markets, whether those markets are closely related or not.

In a first separate aspect of the present invention, a method of facilitating interpersonal connections includes compiling, by a server, a plurality of network databases, with each network database being associated with one of a plurality of remote devices and including contact relationship data for one or more level 1 contacts from the respectively associated remote device. The contact relationship data for each of the one or more level 1 contacts includes: a contact identifier, contact information, one or more contact categories, and a contact sharing authorization identifier. The server receives a query from a first remote device among the plurality of remote devices. The query includes one or more query categories which are to be matched with contact categories included in the network databases. The server generates query results by querying the contact relationship data within the network databases for all level 1 contacts of the first remote device and for predetermined level 2 contacts associated with the first remote device, wherein the queried level 2 contacts are determined by each contact sharing authorization identifier respectively associated with each level 2 contact. The server sends the query results to the remote device.

In a second separate aspect of the present invention, a system for facilitating interpersonal connections includes a plurality of remote devices and a server, all of which are configured with respective software to perform instructions. Each remote device is configured by the software to synchronize, for one or more level 1 contacts, a contact identifier and contact information between contact relationship data on the respective remote device and a user contact database stored on the respective remote device. Each remote device is also configured to insert into the contact relationship data one or more contact categories and a contact sharing authorization identifier, both being assigned by a user of the respective remote device to each of the one or more level 1 contacts included in the contact relationship data. The server is configured by the software to receive the contact relationship data from each of the plurality of remote devices and to store the received contact relationship data in one of a plurality of network databases. The server is also configured to receive a query from a first remote device among the plurality of remote devices, where the query includes one or more query categories to be matched with contact categories included in the network databases. The server is configured to then generate query results from the query and send the query results to the first remote device. The query results are generated by querying the contact relationship data within the network databases for all level 1 contacts of the first remote device and for predetermined level 2 contacts associated with the first remote device, wherein the predetermined level 2 contacts are determined by each contact sharing authorization identifier respectively associated with each level 2 contact.

The aforementioned separate aspects may be employed in combination.

Accordingly, an improved system and method of facilitating interpersonal connections are disclosed. Advantages of the improvements will be apparent from the drawings and the description of the preferred embodiment.

### BRIEF DESCRIPTION OF THE DRAWINGS

The foregoing summary, as well as the following detailed description of the exemplary embodiments, will be better understood when read in conjunction with the appended drawings. It should be understood, however, that the invention is not limited to the precise arrangements and instrumentalities shown in the following figures:

FIGS. 1A & 1B schematically illustrate a system for facilitating interpersonal connections;

FIG. 2A is a flowchart showing a process for compiling a database as part of a method for facilitating interpersonal connections;

FIG. 2B schematically illustrates contact data stored in a database;

FIG. 2C schematically illustrates relationships between contact data stored in multiple databases;

FIG. 2D is a flowchart showing a process for receiving and responding to query requests as part of a method for facilitating interpersonal connections;

FIG. 2E is a flowchart showing a process of filtering query results in a method for facilitating connections;

FIGS. 3A-3I illustrate exemplar screenshots of a software implementation on a mobile device as part of a system for facilitating connections.

### DETAILED DESCRIPTION OF THE INVENTION

Features of the present invention may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g. code). Various processors may be embodied in computer and/or server hardware of any suitable type (e.g. desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g. software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs is referred to hereinafter as a “programmable device”, or just a “device” for short, and multiple programmable devices in mutual communication is referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g. internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present invention may be embodied in the form of computer-implemented processes and apparatuses such as processor-based data processing and communication systems or computer systems for practicing those processes. The present invention may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

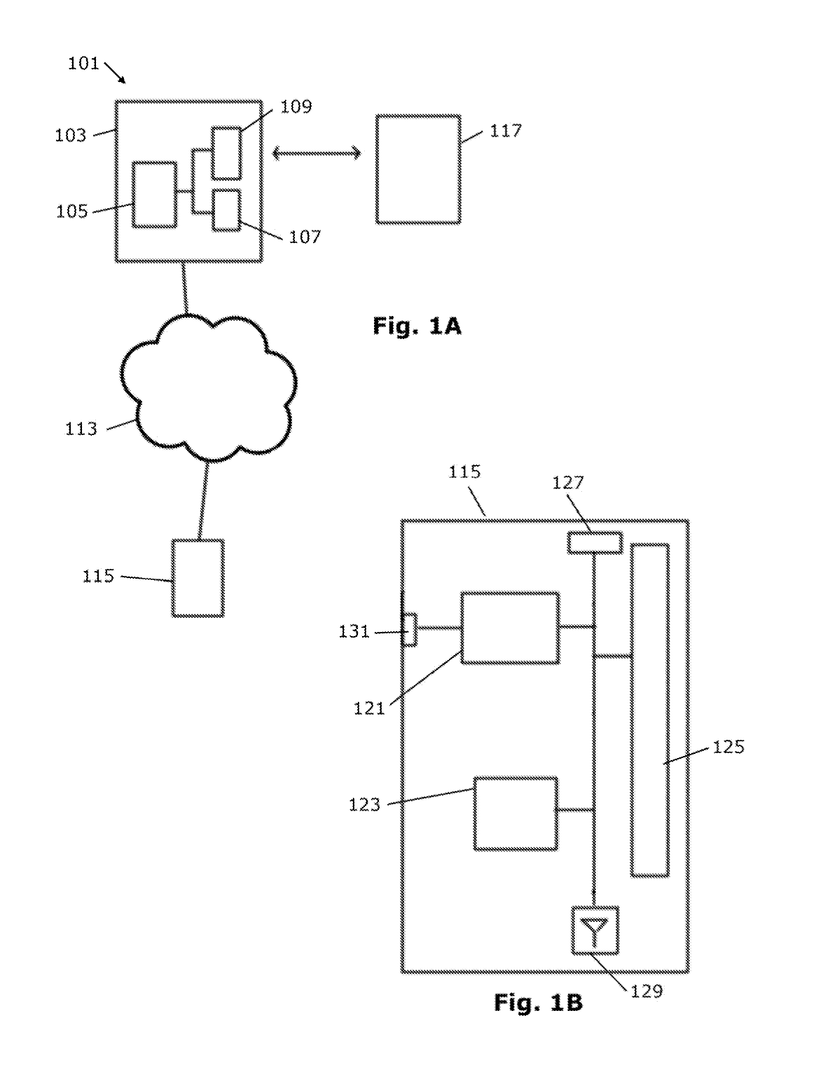

Turning in detail to the drawings, a system 101 for facilitating interpersonal connections is shown in FIG. 1A. The system includes a server 103 which operates in a networked environment to interact with other programmable devices over one or more networks. The network environment may include and operate over a public network such as the Internet, over a private network, or any combination of public and private networks. The networks themselves may be wired networks, wireless networks, or any combination of wired and wireless networks. The server includes, in the embodiment shown, a processor 105 of general programmability, a volatile memory 107, and a non-volatile storage device 109. Additional processors, volatile memory spaces, and non-volatile storage devices may be included as desired based on specifications of a particular implementation.

The server 103 is communicably connected to a database storage 117, which may reside on the server 103 itself or on a separate server or storage device. In instances where the database storage 117 is not integrated with the server 103, the database storage 117 may be communicably connected to the server 103 over any of the different types of networks.

In the embodiment illustrated in FIG. 1A, the server 103 is networked using the Internet 113, a generally public network, to a remote programmable device 115. Although the server may be networked to multiple programmable devices simultaneously, only one is shown for purposes of simplifying the drawings and the ensuing description. The remote device 115 serves as a point of data acquisition for the server 103. The remote device 115 may be any type of programmable computing device, and it may be one that is configured to be a mobile device, such as a laptop, notebook, tablet, cellular phone, and the like. The server 103 may use any desired protocols and file formats to electronically communicate with the remote device 115, with the protocols and file formats being those that are deemed appropriate for the specifications of a particular implementation.

The server 103 interacts with the remote device 115 to compile and store information in the database storage 117. The server 103 receives contact relationship data from the remote device 115 and saves that contact relationship data in a database stored on the database storage, wherein contact relationship data from different remote devices are stored in separate databases. To these ends, the server 103 is programmed to perform the data compilation and database management functionality that are described in further detail below. The server is also programmed to provide access to data stored in the database storage 117 to other servers or programmable devices using one or more application program interface (API), although such functionality is beyond the scope of the present disclosure. As alternatives, data acquisition and data distribution may be handled by multiple servers accessing the database storage, and the databases on the database storage may be duplicated, with the duplicates remaining synchronized, to provide the same functionality.

In performing data compilation, the server 103 is programmed to communicate with the remote device 115 as appropriate to gather data for storing in the database storage 117. Typically, the mobile remote device 115 will initiate communication with the server 103 to provide data for the associated database. The server 103 may, at times, also initiate communications with the remote device 115 in order to gather or verify data for the associated database, or to otherwise communicate with the user of the remote device 115. Those of skill in the art will recognize that the databases for each of the remote devices may be maintained as a single, integrated database, or as any number of databases as desired based on design choice.

FIG. 1B illustrates a detailed schematic view of the basic components of a remote programmable device 115. In the embodiment shown, the remote device 115 is a mobile device, such as a smart phone. This remote device 115 includes a programmable processor 121 communicably coupled to the other components, which include one or more types of memory 123, a display 125, a global positioning system (GPS) subsystem 127, a transceiver subsystem 129, and one or more actuatable buttons 131 which a user may use to control operation of the remote device 115 through interaction with the software programming. In addition, the display 125 may be a touch-sensitive LED type of display screen which is controlled by the processor and permits the user to control operation of the remote device 115 through interaction with the software programming. The transceiver subsystem 129 may include one or more modes of wireless and/or wired communications, of which several are well known in the art of mobile computing devices, such as cellular communications systems, Wi-Fi communications systems, Ethernet communications systems, and the like.

One or more of the subsystems may be partially or wholly integrated with the processor 121. The processor 121 is programmed, either through software programming or hardware programming, to utilize each of the components for carrying out the programming. The processor 121 operatively communicates with the memory 123 to store and retrieve programming and/or data during use as instructed by programming, whether that programming is represented in software stored in the memory or hard coded into other components of the remote device 115.

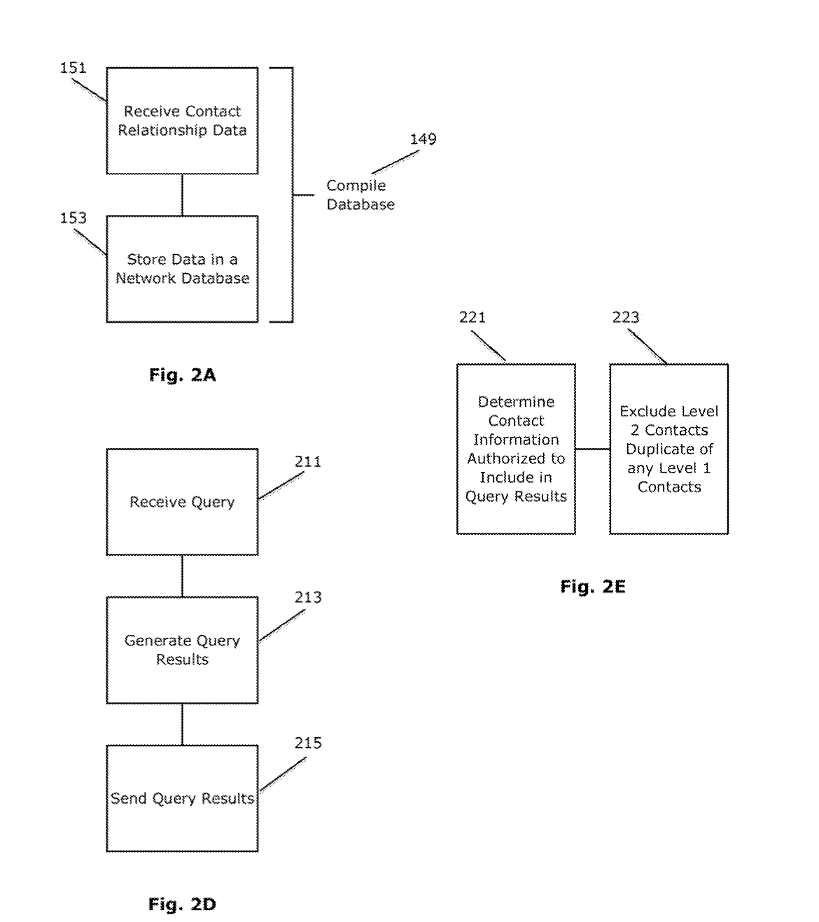

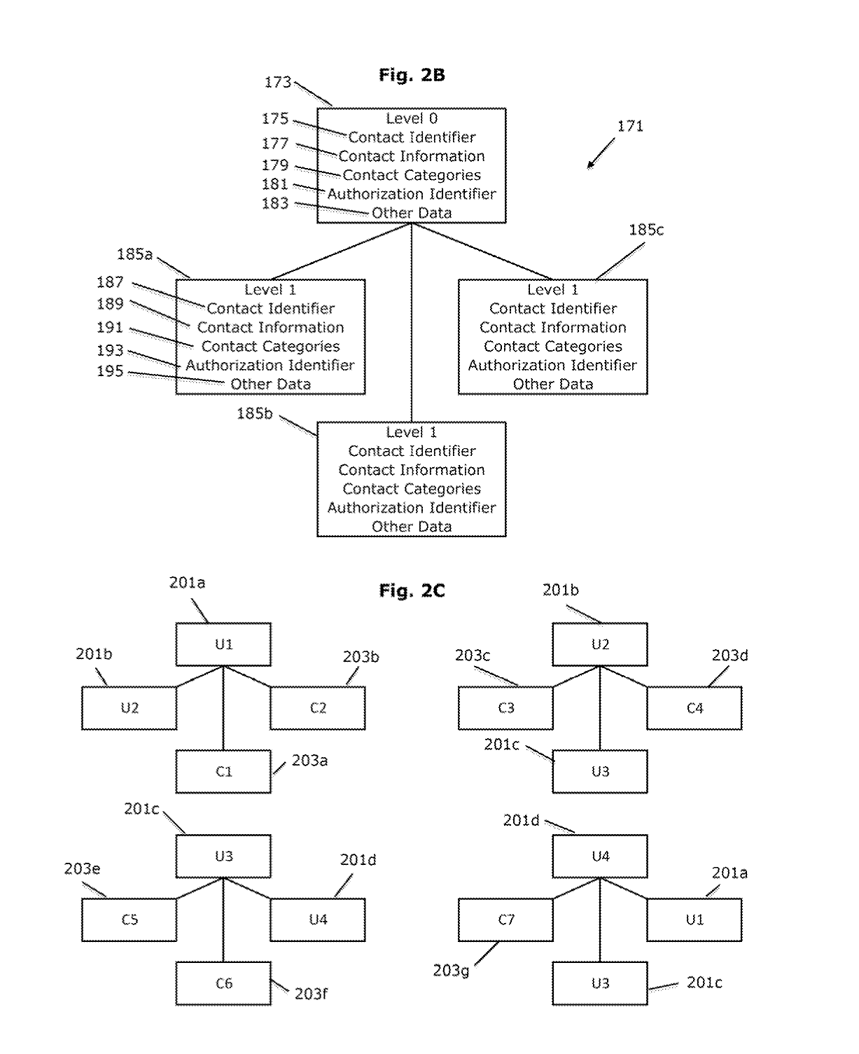

A process of compiling 149 a database is shown in FIG. 2A. This process, and those of FIGS. 2D and 2E, are intended to be implemented in software executed by a server, with the server being in communication over a network with a remote programmable device employed by a user. The compiling process 149 is repeated as often as necessary for each user, and it is repeated as necessary to synchronize updated contact relationship data between the server and each remote device. The compilation process 149 begins with receiving 151 contact relationship data from a user, followed by storing 153 the received contact relationship data in a network database that is associated with the remote device from which the contact relationship data was received.

The very first time a user connects to the server using a remote device, the remote device transmits contact relationship data that includes all, or substantially all, of the personal contacts the user maintains on the remote device. In doing this, the application on the remote device builds the contact relationship data from the personal contacts stored on the remote device, and for each of the contacts included in the personal contacts data, the application extracts from the personal contacts data at least a contact name or business name and contact information such as telephone numbers, street addresses, and email addresses. Other information about each contact in the personal contacts data may be excluded from the contact relationship data, or the user may be given the option to include or exclude such additional information about the personal contacts. The contact relationship data built and stored by the application on the remote device is separate from the personal contacts stored on the remote device. This means that the remote device stores one database of personal contacts and a second database of the contact relationship data. It is this latter database on the mobile devise that is sent to and synchronized with the network database maintained by the server.

In some embodiments, the application on the remote device may store a copy of the personal contacts database stored on the remote device, then collect data from the user about the personal contacts. The personal contacts database and the collected data could then be communicated to and synchronized with the server. As is well known in the art, a collection of data, such as contacts or data relating to contacts, may be organized into a database, so that the data collected from the user about the contacts in the personal contacts database may be organized as merely data, or it may be organized to be its own database. In the latter instance, two databases may be communicated to and synchronized with the server. In practice, any of the databases described herein that are stored on the same device (e.g., the server or one of the remote devices) could be integrated together, or alternatively they may be divided into multiple databases, as a matter of design choice.

Once the contact relationship data is initially populated with data for the user's personal contacts, those personal contacts become the user's network contacts once the initial set-up process with the server is complete. A user's network contacts are also referred to below as “level 1” contacts for that user. A user also has “level 2” contacts, which are the network contacts for each of the user's level 1 contacts. A user also has “level n” contacts which are the network contacts for each of the user's level n−1 contacts. Finally, as discussed below, the user's contact information is included in the contact relationship data, and for purposes of simplifying the description, each user is their own “level 0” contact.

For those personal contacts that are included in the contact relationship data, the user is provided with the opportunity to assign contact categories and to assign a contact sharing authorization identifier. The contact sharing authorization identifier may provide fine-grained control to the user over whether a personal contact in the contact relationship data is shared and to what extent information about each personal contact is shared with other users of the system. The contact categories may reflect the types of goods or services offered by a network contact included in the contact relationship data. Alternatively, or in addition to, the contact category may include any variety of information about a contact. For example, the contact category may reflect such things as the industry, specialization within a given industry or type of position held by the network contact, such as business owner, president, CEO, vice president, sales manager, and the like. The contact category data may be included as a free-form entry field, or the software may present the user with a list of choices for making a selection. The manner in which the contact category data is collected from the user for association with a network contact is a matter of design choice.

In an alternative embodiment where the system is used to make personal connections, such as connections made for dating or other connections that may not typically involve a commercial transaction, the contact category data may reflect more personal descriptors of each network contact. For example, when the system is implemented as part of a dating service, the contact category data may include race, religion, personal interests, etc., among any other desired type of information.

The contact sharing authorization identifier has two base modes, and may be enhanced by adding any number of additional modes to provide a user with even greater flexibility for searching network contacts, sharing information about network contacts, and ranking the network contacts within a query result. The different modes of the contact sharing authorization identifier may be represented by the software by any alpha-numeric string, with a unique string representing each mode. In some embodiments, the authorization identifier may represent a combination of modes, by including two or more sub-strings, or data words, thereby allowing the user with even greater flexibility for sharing network contacts. The two basic modes for the authorization identifier are: “non searchable” and “searchable.” These modes, along with any other included modes for the contact sharing authorization identifier, may be represented by any alphanumeric reference within the network database. The “non searchable” mode marks a network contact to inform the server managing the network database that the network contact so marked is not searchable by the other users having as a level 1 contact the user who so marked a network contact. In the default configuration, the server does not allow contacts to search any level n contacts, where n≧2, regardless of how those level n contacts are marked by the contact sharing authorization identifier. However, this default configuration may be changed as a matter of design choice. The “searchable” mode marks a network contact to inform the server managing the database that the network contact so marked is searchable by the level 1 contacts of a particular user. Additional modes for the contact sharing authorization identifier act in addition to, or in combination with, the two basic modes.

The contact sharing authorization identifier may include a sub-string, or an additional data word, which serves to inform the server which parts of the contact relationship data associated with a particular contact are sharable as part of a query result. This additional substring serves as a secondary authorization identifier. This secondary authorization identifier may have two modes, although in some embodiments, the secondary authorization identifier may include more than two modes, thereby providing the user with even greater flexibility regarding the information shared about network contacts. The two basic modes for the secondary authorization identifier are: “do not share” and “share.” The “do not share” mode marks a network contact to inform the server managing the database that the contact relationship data of the network contact is not to be shared on behalf of the user who assigned the mode. The “share” mode marks a network contact to inform the server managing the database that the contact relationship data for the network contact so marked is to be shared on behalf of the user who assigned the mode. Additional modes for the secondary authorization identifier act in addition to, or in combination with, the two basic modes. These modes, along with any other included modes for the secondary authorization identifier, may be represented by any alphanumeric sequence within the contact sharing authorization identifier. As an alternative, the secondary authorization identifier may be included as a separate, distinct entry in the network database, apart from the contact sharing authorization identifier.

One overlay option is to allow the user to identify specific contact information associated with each network contact to share with other users. By way of examples, a user may choose to share only the contact name and phone number for a particular network contact, or a user may choose to share the contact name and some or all of the data entered in a free-form entry field associated with the network contact. Data in the free-form entry field might tell others to contact the user for additional contact information, or it might provide additional details about a network contact, or instructions on how to make contact, or any other information the user desires to relay to other users of the system. As can be seen from the last example, other data fields associated with network contacts in the database may be selectively shared by a user when additional modes are provided for sharing network contacts using the secondary authorization identifier

The user's personal contact data is also transmitted from the remote device to the server along with the contact relationship data. The software on the remote device presents the user with the option to show their name or a business name, and the user is also provided with the opportunity to assign contact categories and a contact sharing authorization identifier. This personal contact data is stored in the same database in which the contact relationship data for each particular user is stored.

The contact relationship data and the personal contact data received from each user is synchronized with the database that is maintained by the server for each user. As part of the synchronization process, the server identifies those network contacts from different users who are the same, using the name and contact information (e.g., address, phone number, email address, etc.) to identify network contacts from different users who are one and the same contact, and the server may assign a unique identifier to all variations of such duplicative contact information, among the databases maintained for each of the users, belonging to one and the same contact in order to harmonize such contact's information across the database.

FIG. 2B shows an example of the relational data structure 171 for contact relationship data and personal contact data, for a user 173 and that user's level 1 contacts 185a-c, as it might exist in a network database. The network database maintains the personal contact data for the user 173, including the contact identifier 175, which may be the user's name or business name, contact information 177, which may include any one or more of a street address(s), phone number(s), and email address(s), and contact categories 179, as assigned by the user 173 (as a level 0 contact). The personal contact data may also include a sharing authorization identifier 181, assigned by the user for their own personal contact data, and other data 183 the user chooses to share with other users of the system may also be included in the personal contact data for the user. The sharing authorization identifier 181 assigned by a first user to their own personal contact data may serve to override, as described below, the sharing authorization identifiers set by other users who have the first user as a level 1 contact. This is achieved through propagation of the first user's personal contact data to the databases of the other user's. For the other data 183 that may be stored and shared, the user may choose to include more detailed description about professional services that are offered. The network database also maintains information for the user's level 1 contacts 185a-c, including the contact identifier 187, which may be the contact's name or business name, contact information 189, which may include any one or more of a street address(s), phone number(s), and email address(s), contact categories 191, as assigned by the user 173, the contact sharing authorization identifier 189, as assigned by the user 173, and any other data 195 that was entered by the user 173 about the particular contact 185a-c. In addition, any other data entered by the user 173, about the contacts 185a-c, may also be included in the database.

FIG. 2C shows some relationships that may be identified between network databases associated with different users 201a-d. Although each user 201a-d is shown with three network contacts, it is understood that each user may have any number of contacts, and different numbers of contacts as compared to other users. As shown, the first user 201a has three level 1 contacts, the second user 201b and contacts 203a, 203b; the second user 201b has three level 1 contacts, the third user 201c and contacts 203c, 203d; the third user 201c has three level 1 contacts, the fourth user 201d and contacts 203e, 203f, and the fourth user 201d has three level 1 contacts, the first user 201a, the third user 201c, and a contact 203g. With these network databases, the following relationships can be identified: the third user 201c and contacts 203c, 203d are level 2 contacts for the first user 201a; the fourth user 201d and contacts 203e, 203f are level 2 contacts for the second user 201b; the first user 201a and contact 203g are level 2 contacts for the third user 201c—the third user 201c is also their own level 2 contact; and the second user 201b and contacts 203a, 203b, 203e, 203f are level 2 contacts for the fourth user 201d—the fourth user 201d is also their own level 2 contact. These relationships may be identified by the server at the time contact relationship data and personal contact data is transmitted to the server, or at any later time when the server has available processing cycles. As an alternative, a second server may be employed to process the databases, identify relationships between various users, and synchronize data.

Additional levels of relationships may also be identified from the simplified examples of databases presented in FIG. 2C. These additional relationships include: the second user 201b and contacts 203a, 203b are level 3 contacts for the third user 201c; and contacts 203c and 203d are level 4 contacts for the third user 203c—the third user 201c is also their own level 4 contact. Although the descriptions below do not address returning level 3, level 4, or any other level n contact, with n>2, in query results, doing so is a matter of design choice and not an inherent limitation of the described systems and processes.

The server maintains the databases by synchronizing contact relationship data and personal contact data, as communications permit, from remote devices accessing the server. Upon each synchronization, when updated contact relationship data is received from a user, that updated contact relationship data is processed in the same manner described above. Updates may occur from a user updating the personal contact data on the remote device or from a user updating data within the software on the remote device (any of the data obtained from the personal contact data or added by the user as part of using the software may be updated). When the user updates contact data using the networking software on the remote device, the updated contact data may also be synchronized with the personal contact data stored on the remote device.

When contact relationship data stored locally on a remote device is updated, the remote device then synchronizes the updated data with the server. In addition, because the server compiles detailed contact information about each contact stored within the database, data from the database may be used to update contact relationship data stored on other user's remote device. For example, when a first user updates their own personal contact data, the updated personal contact data from that first user's remote device is synchronized with the database associated with the first user's remote device, and the updated personal contact data may then be synchronized with the databases of other users, and thereby with the remote devices of other users, so long as the first user is a level 1 contact of the other users. In this way, the updated personal contact data for one user may be propagated to other users who have that one user as a level 1 contact in their own network database.

When the personal contact data of the first user also includes a sharing authorization identifier, and the personal contact data is propagated to other users, the server may be programmed to use part or all of the propagated sharing authorization identifier in lieu of the sharing authorization identifiers set by the other users who have that first user as a level 1 contact. In embodiments where the sharing authorization identifier only includes modes for making a contact “searchable” or “non searchable,” a user could effectively hide themselves from other users by setting their own sharing authorization identifier to “non searchable.” Although this ability may not be desirable in some embodiments, in other embodiments users may view it as a useful feature. In embodiments where the sharing authorization identifier includes multiple sub-strings, the server may be programmed to have all sub-strings set by a user override the sharing authorization identifiers of other users, or the server may be programmed to permit a user to override the sharing authorization identifiers of other users for only certain ones of the sub-strings. By way of example, the server may allow a user to set their own sharing authorization identifier to override a secondary authorization identifier, but not to override the sub-string which determines whether other users can make the first user, as a level 1 contact of the other users, searchable. By giving a user the ability to override predetermined parts, or none or all, of the sharing authorization identifier, design choices can be made that improve the usability, and usefulness, to users of the system for facilitating interpersonal connections, depending upon the needs of a particular implementation.

A user who has synchronized their contact relationship data with their associated database may access the server using a remote device programmed with software to access the server and submit to the server a query of the databases. FIG. 2D shows the process steps for the server for searching the databases and providing query results. In forming a query, the software on the remote device may permit the user to freely enter terms to use for searching the contact categories, or alternatively the software may present the user with a predefined list of contact categories to choose from.

In some embodiments, to provide quicker results to the user, the software on the remote device may perform a search of the user's level 1 contacts, while submitting the query to the server to perform a search of the user's level 2 contacts.

After receiving a query 211, if the query includes freely entered query terms, the server may use fuzzy logic to match those query terms up with contact categories used in the databases. This step is not required if the user chooses from a predefined list of contact categories. The server also determines if the query includes a geographical identifier, which tells the server to limit the search results to a geographical region, which may be defined by a radius, determined by nearby zip codes, by area codes, cities, or any other data in the databases that at least roughly defines a limited geographical region. When a geographical identifier is included, the server limits the search results according to the limited geographical region selected by the user. If no geographical identifier is included in the query, then the search results may inform the user that the search was not geographically limited.

Once the scope of the received query 211 is determined by the server, the server performs the query on the databases to generate query results 213, and the generated query results are sent to the mobile device 215 from which the query originated. As part of generating the query results 213, the server searches the level 1 contacts of the user submitting the query, and those level 2 contacts that have a contact sharing authorization identifier which indicates that the level 2 contact is “searchable.” None of the “non searchable” level 2 contacts of the user submitting the query are searched by the server or included in the query results. As a design choice, the server could be programmed to search additional level n contacts, with n≧3.

As part of generating the query results 213, the server filters some data from the query results in order to make the results more useful to the user of the remote device. One embodiment of this filtering process is shown in FIG. 2E. The filtering steps may be performed in any order, however there may be processor time advantages to performing the filtering in one order as opposed to another order.

The first applied filter 221 determines the amount of data about any level 2 contact that the server is authorized to include in the query results. This filter may be useful when finer-grained control is offered to the users through multiple modes of the contact sharing authorization identifier to determine the scope of information each user wants to share about their own level one contacts. By way of example, if a level 2 contact which is included in the query results has the secondary authorization identifier set to “do not share,” then the query will return the name of the associated level 1 contact, indicating that the user to whom the query results are sent should contact the associated level 1 contact in order to obtain contact information for the contact referenced in the query result.

The second applied filter 223 in this embodiment is intended to simplify the query results sent to the user, in order to make the query results more useful. With this filter, the server excludes a level 2 contact from the database if it is a duplicate of a level 1 contact or a level 0 contact (the latter being the user who submitted the query). In embodiments where additional levels of contacts are included in query results, the server preferably filters any level n contact if it is a duplicate of a level m contact, where m<n. Exceptions may be made for this rule, for example when the contact sharing authorization identifier includes additional modes implementing more fine-grained control, and such modes indicate that an exception should be made. Other exceptions may also be applied, based on any desirable criteria, depending upon the design implementation for the software.

By way of another example, for a level 2 contact included in the query results, which is a level 2 contact by way of two level 1 contacts for the user, if each of those level 1 contacts have a different secondary authorization identifier for the level 2 contact, then the server may include in the query results information about the level 2 contact based upon the broader of the two secondary authorization identifiers. Implementation of this second filter is a matter of design choice, although certain users may find the system and service more attractive knowing that the data stored in the database about them is stingily guarded.

As mentioned above, in some embodiments the server may integrate the databases stored for each of the users into a single database. In such embodiments, it may be beneficial for the server to search all level 2 contacts for a user, even those marked as “non searchable,” followed by filtering out the “non searchable” level 2 contacts from the query results. This process of searching all contacts of a predetermined level, followed by filtering out “non searchable” contacts, may be implemented for any level n contacts, where n>1, as part of a query and filtering the query results.

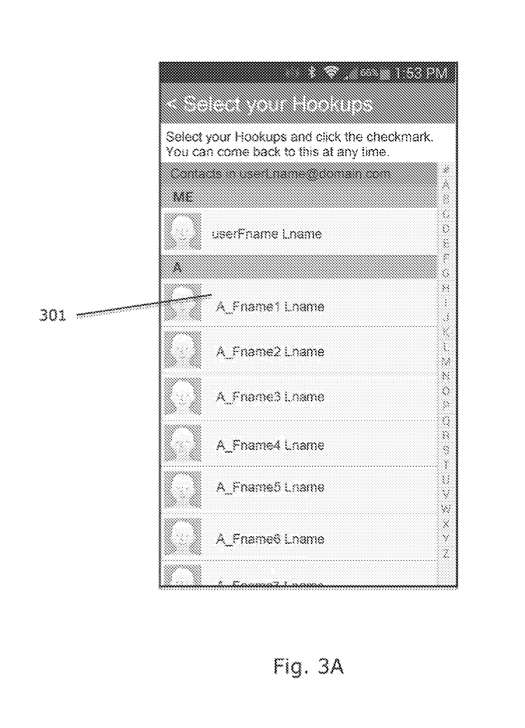

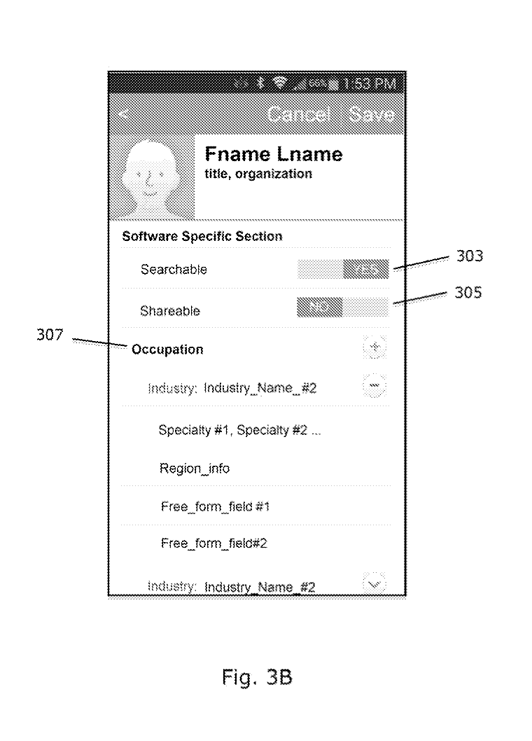

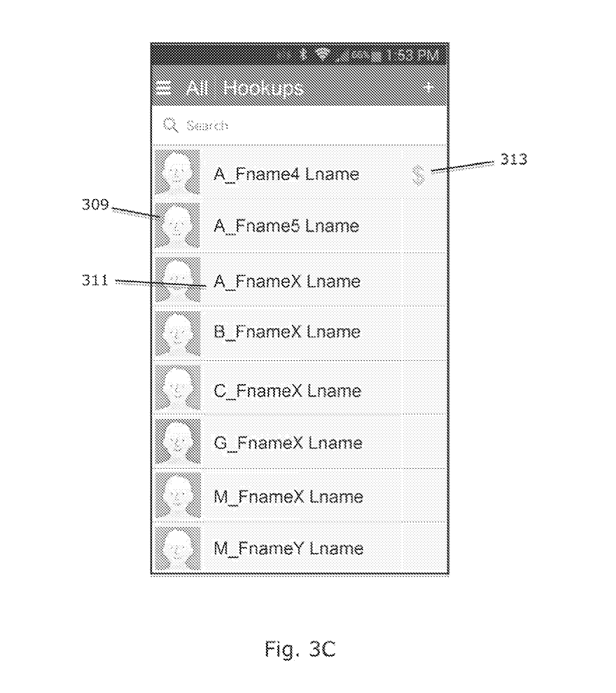

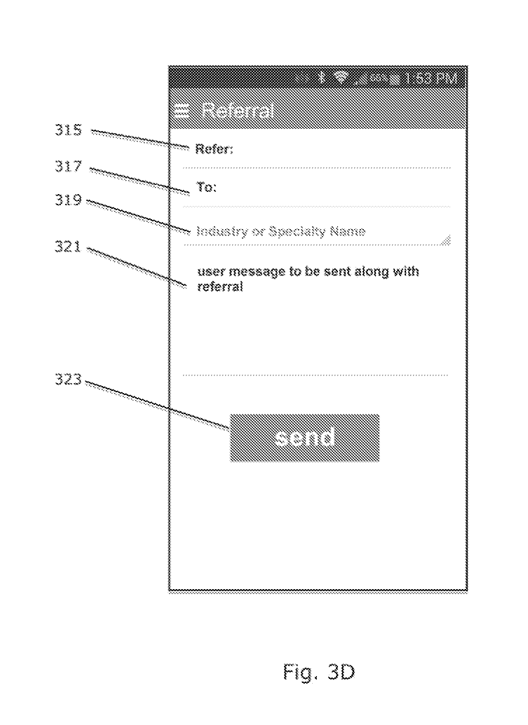

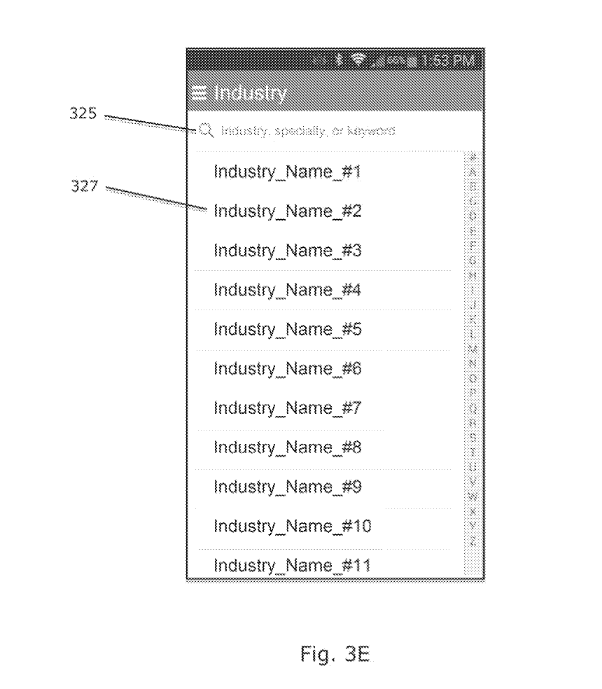

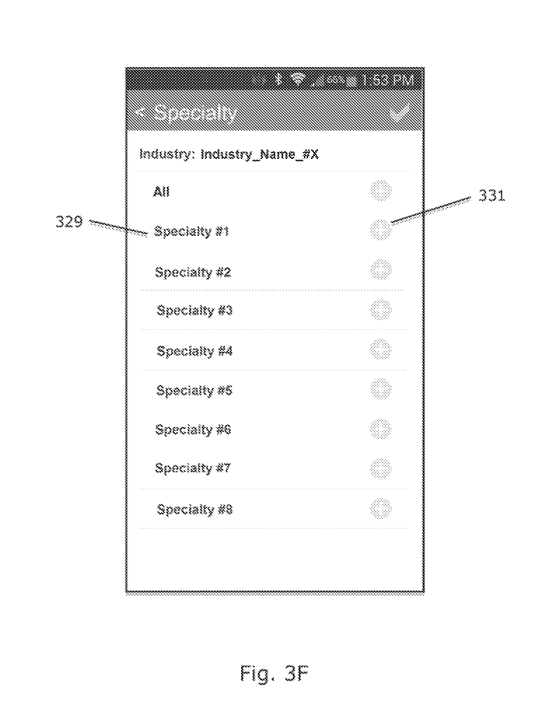

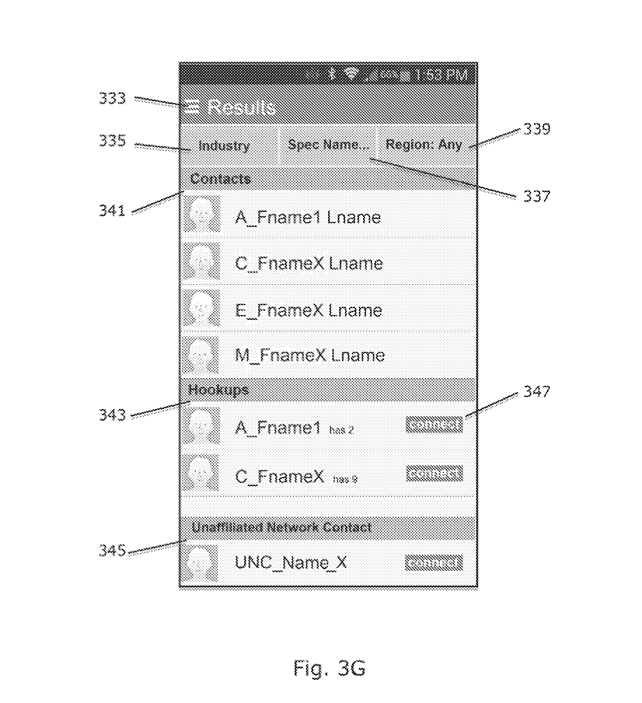

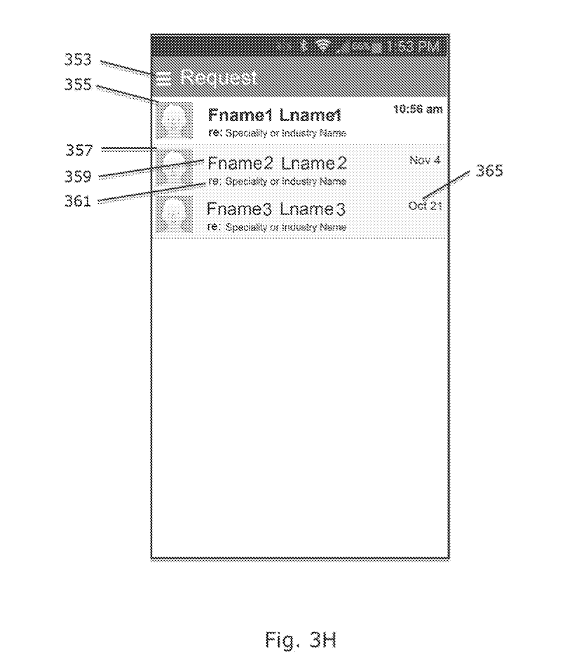

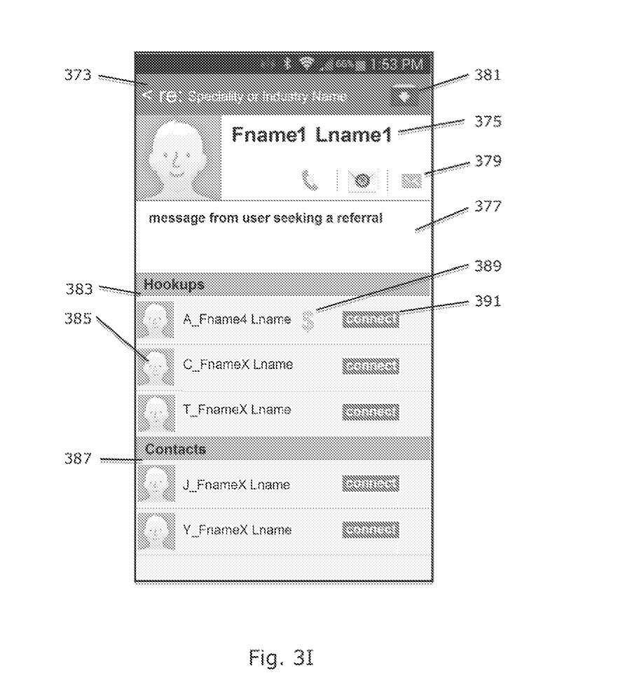

FIGS. 3A-3I illustrate a display screen for a mobile device programmed with software to implement the user experience communicating with the server and the database. One of skill in the art will recognize that the implementation shown in this embodiment is readily adaptable to other types of remote devices, such as desktop or laptop computers, tablet computers, or other types of computing devices. The software may also be implemented on any type of device having access to the server over a network. In each of these example display screens, a network contact for whom the user has set the contact sharing authorization identifier to “searchable” is referred to as a “hookup.” In the following examples, the contact sharing authorization identifier is formed of two sub-strings, a first sub-string which includes two modes for a user to mark a network contact as “non searchable” or “searchable,” and a second sub-string which includes two modes for a user to mark a network contact as “do not share” or “share.”

FIG. 3A shows a partial list of personal contacts 301 that are presented for the user to determine which of the personal contacts 301 are to have their contact sharing authorization identifier set to “searchable,” which may be done upon initial setup of the software or at any time thereafter. FIG. 3B shows a screen on which options are presented to the user to set additional information associated with a network contact, which may be done upon initial setup of the software or at any time thereafter. This information includes a first selectable option 303 to toggle the first sub-string of the contact sharing authorization identifier between its two modes and a second selectable option 305 to toggle the second sub-string of the contact sharing authorization identifier between its two modes. The user may also assign multiple contact categories 307 from this screen, which may include such items as the industry, specialization within such industry, regional and geographic identifiers and multiple various free-form entry fields.

A screen showing a list of network contacts 309 whom the user has designated as a “hookup,” by setting the respective contact sharing authorization identifiers to “searchable,” is shown in FIG. 3C. This screen shows the contact names 311 of the network contacts who are being shared by the user. One or more of the contact names 311 may be associated with an icon 313 which is representative of specific information about a contact category assigned to the network contact.

A screen allowing a user to directly make a network contact referral to one of their own level 1 contacts is shown in FIG. 3D. As can be seen, the user is provided with entry fields for indicating the name of the level 1 contact being referred 315, the name of the level 1 contact to whom the referral is being made 317, the relevant contact categories that are the basis for the referral 319, and a free-form message field 321 for entering a personalized message to the level 1 contact to whom the referral is being made. Once the user has entered the appropriate information, the “send button” 323 may be selected to send the message to the indicated recipient.

A search screen is shown in FIG. 3E. This search screen includes two methods of submitting search terms to query the database: a free-form entry search field 325 and a list of selectable contact categories 327.

A second search screen is shown in FIG. 3F. In this embodiment, the user is provided finer-grain control over the query by being presented with a list of contact sub-categories 329. An icon 331 may be used by the user to designate contact sub-categories 329 in order to refine the query, and therefore the query results.

Query results 333 are displayed on the screen shown in FIG. 3G. In this embodiment, the query results may be constrained by the user by selecting among the contact category 335, the contact subcategory 337, and a geographic identifier 339. The query results shown include the list of level 1 network contacts 341 matching the query criteria, the list of level 1 network contacts 343 that have a level 1 network contact (the user's level 2 network contact) matching the query criteria, and an unaffiliated network contact 345 that is neither a level 1 nor a level 2 contact of the user, yet is present in the databases and matches the query criteria. In some embodiments, the unaffiliated network contact 345 shown may be a commercial entity which has paid to be listed based on the query criteria. Selection of the “connect button” 347 on this screen provides the user a method to request an introduction or learn more information about the level 2 network contact or unaffiliated network contact 345. Each contact shown in the query results 333 may be selected by the user to show contact details.

A list of requests 353 received by a user is shown in FIG. 3H. In this list of requests 353, those requests that have not yet been viewed 355 are shown with a visual difference as compared to those requests that have already been viewed 357 by the user. Each request shown in the list of requests 353 includes the name of the user making the request 359, and the category or subcategory 361 to which the request relates. Each request shown in the list 353 may be selected by the user to show the details of the request. Each request shown in the list 353 also includes a date or time indicator 365.

FIG. 3I shows a screen which includes the details of a request. These details include the subject of the message 373, which reflects the category of the request, the name of the user making the request 375, and the details of the request 377 as entered by the user making the request. This screen also includes selectable icons 379, which permit the user receiving the request to directly communicate with the user making the request, and another selectable icon 381 which allows the user to delete or archive the request message. In addition, this detail screen shows a list of contacts 383 which are query results for a query automatically performed on behalf of the user receiving the request using the category or categories of the request as query categories. This list of contacts 383 differentiates between those level 1 contacts of the user receiving the request with the secondary authorization identifier set to “searchable” 385 (referred to as “hookups” on the screen) and those with the secondary authorization identifier set to “non searchable” 387 (referred to as “contacts” on the screen). The screen may include a symbol 389 associated with specific information about a contact category attributed to the network contact. The screen also includes a “connect button” 391, which is selectable by the user to share contact information about a level 1 network contact to the user making the request 375. Each contact shown in the list of “hookups” 385 and the list of “contacts” 387 may be selected by the user to show contact details.

In addition to enabling a user to forward specific requests to their level 1 contacts, the software may also include a “newsfeed” of recent database queries submitted by a user's level 1 or level 2 contacts. In some embodiments user may have control over which level of contact their newsfeed displays. Such a newsfeed may be monitored by a user, and in the event that the user desires to be of assistance, the user may run their own query to help identify their own level 1 or level 2 contacts who would meet the criteria listed in the newsfeed.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A method of facilitating interpersonal connections, the method comprising:
compiling, by a server, a plurality of network databases, each network database being associated with one of a plurality of remote devices and including contact relationship data for one or more level 1 contacts from the respectively associated remote device, the contact relationship data for each of the one or more level 1 contacts including: a contact identifier, contact information, one or more contact categories, and a contact sharing authorization identifier;
receiving, by the server, a query from a first remote device among the plurality of remote devices, the query including one or more query categories to be matched with contact categories included in the network databases;
generating, by the server, query results by querying the contact relationship data within the network databases for all level 1 contacts of the first remote device and for predetermined level 2 contacts associated with the first remote device, wherein the queried level 2 contacts are determined by each contact sharing authorization identifier respectively associated with each level 2 contact; and
sending, by the server, the query results to the first remote device.

2. The method of claim 1, wherein compiling the database comprises:
receiving, at the server, the contact relationship data from a second remote device among the plurality of remote devices, wherein a user of the second remote device assigns the contact sharing authorization identifier and the one or more contact categories included in the contact relationship data for each of the one or more level 1 contacts associated with the second remote device; and
storing, by the server, the received contact relationship data in one of the databases.

3. The method of claim 2, wherein the contact sharing authorization identifier represents authorization to make the associated level 1 contact available for querying by other ones of the remote devices as one of the predetermined level 2 contacts.

4. The method of claim 2, wherein the contact sharing authorization identifier represents authorization to share the contact identifier and the contact information for the associated level 1 contact on behalf of the user of the second remote device.

5. The method of claim 2, wherein the contact sharing authorization indicator represents authorization to share a predetermined subset of the contact relationship data for the associated contact on behalf of the user of the second remote device.

6. The method of claim 2, wherein the contact relationship data received by the server is synchronized on the second remote device with a user contact database stored on the second remote device.

7. The method of claim 2, wherein the contact relationship data received by the server from the second remote device is kept synchronized between the second remote device and the server

8. The method of claim 1, further including receiving, at the server, personal contact data from a second remote device among the plurality of remote devices, the personal contact data being included in the network database associated with the second remote device.

9. The method of claim 8, wherein the personal contact data includes a user name and user contact information for the user of the second remote device, along with one or more contact categories assigned by the user of the second remote device.

10. The method of claim 8, wherein the personal contact data received by the server from the second remote device is kept synchronized between the second remote device and the server.

11. The method of claim 10, wherein the personal contact data received by the server from the second remote device is kept synchronized between the server and the network database associated with a third remote device, wherein a user of the second remote device is a level 1 contact in the contact relationship data associated with the third remote device.

12. The method of claim 1, wherein the contact relationship data associated with each of the one or more level 1 contacts further includes a free-form data field.

13. The method of claim 1, wherein the contact information includes at least one of a contact address, a contact phone number, and a contact email address.

14. The method of claim 1, wherein the contact identifier includes at least one of a contact name and a contact business name.

15. The method of claim 1, wherein the received query further includes a geographical identifier which serves to geographically limit the query results.

16. The method of claim 1, wherein sending the query results includes filtering the query results to remove any level 2 contact in the query results that is a duplicate of any level 1 contact in the query results.

17. The method of claim 16, wherein the filtering is performed by the server.

18. The method of claim 16, wherein the filtering is performed by the first remote device.

19. A method of facilitating interpersonal connections, the method comprising:
receiving, at the server, contact relationship data from a plurality of remote devices, the contact relationship data from each remote device being synchronized with a user contact database on each respective remote device to include one or more level 1 contacts, the contact relationship data for each of the one or more level 1 contacts including: a contact identifier, contact information, one or more contact categories, and a contact sharing authorization identifier;
storing, by the server, the contact relationship data received from each one of the remote devices in one of a plurality of network databases;
receiving, by the server, a query from a first remote device among the plurality of remote devices, the query including one or more query categories to be matched with contact categories included in the network databases;
generating, by the server, query results by querying the contact relationship data within the network databases for all level 1 contacts of the first remote device and for predetermined level 2 contacts associated with the first remote device, wherein the queried level 2 contacts are determined by each contact sharing authorization identifier respectively associated with each level 2 contact, and wherein the query results are filtered to remove any level 2 contact in the query results that is duplicative of any level 1 contact in the query results; and
sending, by the server, the query results to the first remote device.

20. The method of claim 19, further the contact relationship data received by the server from each of the plurality of remote devices is kept synchronized between each of the plurality of remote devices and the server.

21. The method of claim 19, further including receiving, at the server, personal contact data from a second remote device among the plurality of remote devices, the personal contact data being included in the network database associated with the second remote device.

22. The method of claim 21, wherein the personal contact data includes a user name and user contact information for the user of the second remote device, along with one or more contact categories assigned by the user of the second remote device.

23. The method of claim 21, wherein the personal contact data received by the server from the second remote device is kept synchronized between the second remote device and the server.

24. The method of claim 23, wherein the personal contact data received by the server from the second remote device is kept synchronized between the server and the network database associated with a third remote device, wherein a user of the second remote device is a level 1 contact in the contact relationship data associated with the third remote device.

25. A system for facilitating interpersonal connections, the system comprising:
a plurality of remote devices, each remote device configured with software instructing the respective remote device to:
synchronize, for one or more level 1 contacts, a contact identifier and contact information between contact relationship data on the respective remote device and a user contact database stored on the respective remote device;
inserting into the contact relationship data one or more contact categories assigned by a user of the respective remote device to each of the one or more level 1 contacts included in the contact relationship data; and
inserting into the contact relationship data a contact sharing authorization identifier assigned by the user of the respective remote device to each of the one or more level 1 contacts included in the contact relationship data; and
a server configured with software instructing the server to:
receive the contact relationship data from each of the plurality of remote devices;
store the received contact relationship data in one of a plurality of network databases;
receive a query from a first remote device among the plurality of remote devices, the query including one or more query categories to be matched with contact categories included in the network databases;
generate query results by querying the contact relationship data within the network databases for all level 1 contacts of the first remote device and for predetermined level 2 contacts associated with the first remote device, wherein the predetermined level 2 contacts are determined by each contact sharing authorization identifier respectively assigned to each level 2 contact; and
send the query results to the first remote device.

26. The method of claim 25, wherein the contact relationship data received by the server from each of the plurality of remote devices is kept synchronized between each of the plurality of remote devices and the server.

27. The method of claim 25, wherein the software further instructs the server to:
receive personal contact data from each of the plurality of remote devices; and
store the personal contact data received from each one of the remote devices in the one of the network databases respectively associated with each one of the remote devices.

28. The method of claim 27, wherein the personal contact data includes a user name and user contact information for the user of the second remote device, along with one or more contact categories assigned by the user of the second remote device.

29. The method of claim 27, wherein the personal contact data received by the server from each of the plurality of remote devices is kept synchronized between the server and each respective one of the plurality of remote devices.

30. The method of claim 25, wherein the contact sharing authorization identifier represents authorization to make the associated level 1 contact available for querying by other ones of the remote devices as one of the predetermined level 2 contacts.

31. The method of claim 25, wherein the contact sharing authorization identifier represents authorization to share the associated level 1 contact on behalf of the user assigning the contact sharing authorization identifier.

32. The method of claim 25, wherein the contact sharing authorization indicator represents authorization to share a select subset of the contact relationship data for the associated contact on behalf of the user assigning the contact sharing authorization identifier.

33. The method of claim 25, wherein the software further instructs the remote device to receive input from the user of the respective remote device to enter supplemental information into a free-form data field for each of the one or more contacts included in the contact relationship data.

34. The method of claim 25, wherein the contact information includes at least one of a contact address, a contact phone number, and a contact email address.

35. The method of claim 25, wherein the contact identifier includes at least one of a contact name and a contact business name.

36. The method of claim 25, wherein the received query further includes a geographical identifier which serves to geographically limit the query results.

37. The method of claim 25, wherein sending the query results includes filtering the query results to remove any level 2 contact in the query results that is a duplicate of any level 1 contact in the query results.

38. The method of claim 37, wherein the filtering is performed by the server.

39. The method of claim 37, wherein the filtering is performed by the first remote device.
